(19) United States
(12) Patent Application Publication
(10) Pub. No.: US 2015/0317303 A1
(43) Pub. Date: Nov. 5, 2015

(54) TOPIC MINING USING NATURAL LANGUAGE PROCESSING TECHNIQUES

(71) Applicant: LinkedIn Corporation, Mountain View, CA (US)

(72) Inventors: Yongzheng Zhang, San Jose, CA (US); Lutz T. Finger, Cupertino, CA (US); Shaobo Liu, Belmont, CA (US)

(73) Assignee: LinkedIn Corporation, Mountain View, CA (US)

(21) Appl. No.: 14/266,633

(22) Filed: Apr. 30, 2014

(51) Int. Cl. G06F 17/28; G06F 17/30

(52) U.S. Cl. CPC G06F 17/28; G06F 17/30867; G06F 17/30539

(57) ABSTRACT

The disclosed embodiments provide a method, system and apparatus for processing data. During operation, the system obtains a set of content items containing unstructured data. Next, the system obtains a set of part-of-speech (POS) tags for lexical items in the set of content items. The system then uses a computer to match the POS tags to one or more POS tagging patterns to obtain a set of candidate topics for the set of content items and extract a set of topics for the set of content items from the set of candidate topics.

### BACKGROUND

1. Field

The disclosed embodiments relate to topic mining. More specifically, the disclosed embodiments relate to topic mining using natural language processing (NLP) techniques.

2. Related Art

Topic mining techniques may be used to discover abstract topics or themes in a collection of otherwise unstructured documents. The discovered topics or themes may be used to identify concepts or ideas expressed in the documents, group the documents by topic or theme, determine sentiments and/or attitudes associated with the documents, and/or generate summaries associated with the topics or themes. In other words, topic mining may facilitate the understanding and use of information in large sets of unstructured data without requiring manual review of the data.

Topic mining techniques typically utilize metrics and/or statistical models to group document collections into distinct topics and themes. For example, topics may be generated from a set of documents using metrics such as term frequency-inverse document frequency (tf-idf), co-occurrence, and/or mutual information. Alternatively, statistical topic models, such as probabilistic latent semantic indexing (PLSI), latent Dirichlet allocation (LDA), and/or correlated topic models (CTMs), may be used to discover topics from a document collection and assign the topics to documents in the document collection.

However, existing topic mining techniques are associated with a number of drawbacks. First, the use of metrics such as tf-idf to identify potential topics may be computationally efficient but may produce a large number of topics with significant overlap. On the other hand, the use of statistical topic models may require significant amounts of training data and/or computational overhead to extract topics from a set of documents.

Consequently, processing of large sets of unstructured data may be facilitated by mechanisms for improving the efficiency and/or accuracy of techniques for mining topics from the unstructured data.

### BRIEF DESCRIPTION OF THE FIGURES

FIG. 1 shows a schematic of a system in accordance with the disclosed embodiments.

FIG. 2 shows a topic-mining system in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method, system and apparatus for processing data. More specifically, the disclosed embodiments provide a method and system for performing topic mining of unstructured data using natural language processing (NLP). For example, NLP techniques may be used to identify a number of topics in a large set of documents and/or other text-based data without manually reviewing or labeling the data or training a statistical model to extract topics from the data.

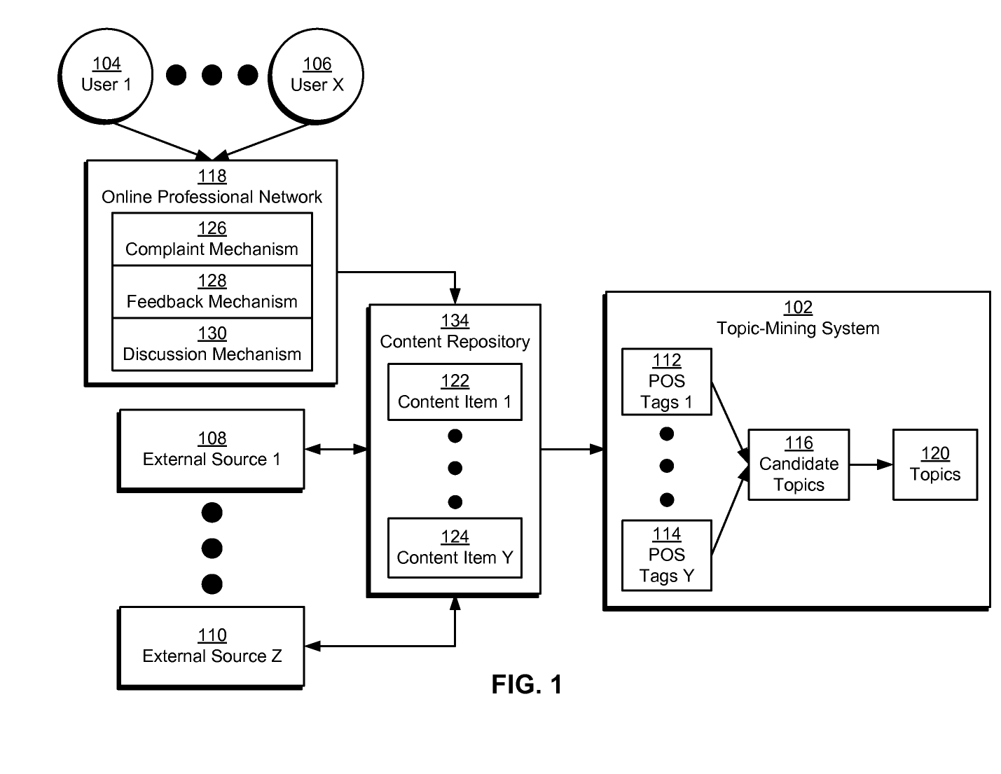

As shown in FIG. 1, the unstructured data may be included in a set of content items (e.g., content item 1 122, content item y 124). The content items may be obtained from a set of users (e.g., user 1 104, user x 106) of an online professional network 118. Online professional network 118 may allow the users to establish and maintain professional connections, list work and community experience, endorse and/or recommend one another, and/or search and apply for jobs. Employers and recruiters may use online professional network 118 to list jobs, search for potential candidates, and/or provide business-related updates to users.

As a result, content items associated with online professional network 118 may include posts, updates, comments, sponsored content, articles, and/or other types of unstructured data transmitted or shared within online professional network 118. The content items may additionally include complaints provided through a complaint mechanism 126, feedback provided through a feedback mechanism 128, and/or group discussions provided through a discussion mechanism 130 of online professional network 118. For example, complaint mechanism 126 may allow users to file complaints or issues associated with use of online professional network 118. Similarly, feedback mechanism 128 may allow the users to provide scores representing the users' likelihood of recommending the use of online professional network 118 to other users, as well as feedback related to the scores and/or suggestions for improvement. Finally, discussion mechanism 130 may obtain updates, discussions, and/or posts related to group activity on online professional network 118 from the users.

Content items containing unstructured data related to use of online professional network 118 may also be obtained from a number of external sources (e.g., external source 1 108, external source z 110). For example, user feedback for online professional network 118 may be obtained from reviews posted to review websites, third-party surveys, other social media websites or applications, and/or external forums. Content items from both online professional network 118 and the external sources may be stored in a content repository 134 for subsequent retrieval and use. For example, each content item may be stored in a database, data warehouse, cloud storage, and/or other data-storage mechanism providing content repository 134.

Because content items in content repository 134 represent user opinions, issues, and/or sentiments related to online professional network 118, information in the content items may be important to improvement of user experiences with online professional network 118 and/or the resolution of user issues with online professional network 118. However, content repository 134 may contain a large amount of freeform, unstructured data, which may preclude efficient and/or effective manual review of the data by developers and/or designers of online professional network 118. For example, content repository 134 may contain millions of content items, which may be impossible to read in a timely or practical manner by a significantly smaller number of developers and/or designers of online professional network 118.

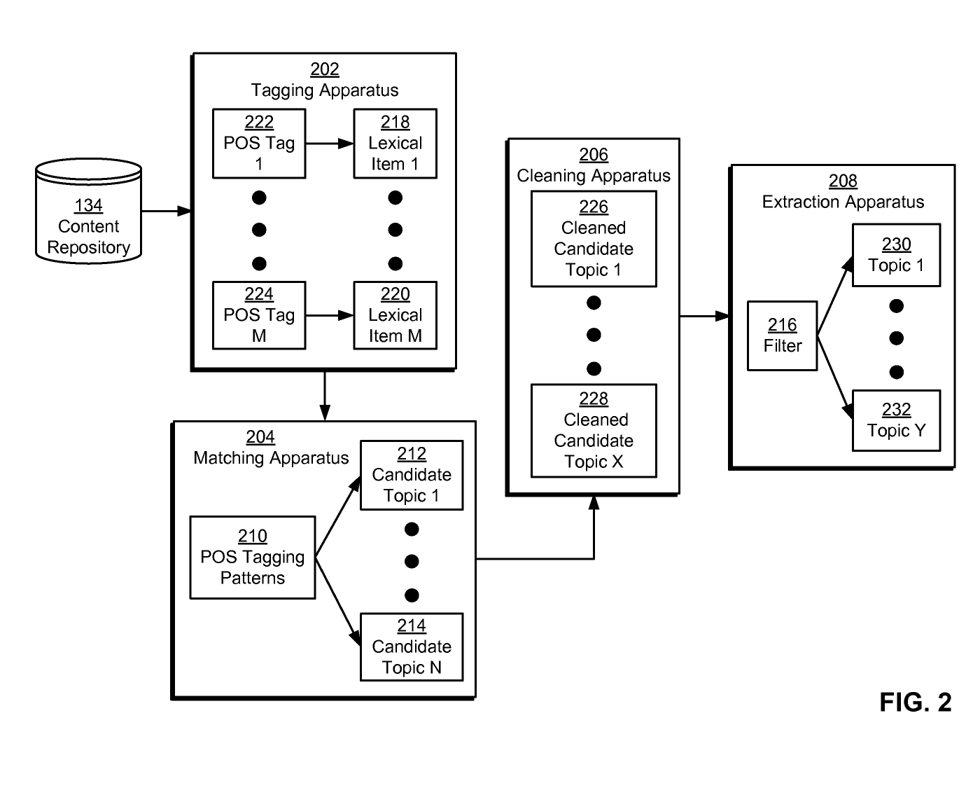

In one or more embodiments, the system of FIG. 1 facilitates understanding and use of information in the content items by performing topic mining of the content items. More specifically, a topic-mining system 102 may use NLP techniques to generate a set of part-of-speech (POS) tags (e.g., POS tags 1 112, POS tags y 114) for each content item in content repository 134. As described in further detail below with respect to FIG. 2, topic-mining system 102 may use the POS tags and one or more POS tagging patterns to obtain a set of candidate topics 116 for the set of content items, which is further processed into a set of topics 120 for the content items. Consequently, topic-mining system 102 may perform topic mining in a way that is both efficient and accurate. Topics 120 may then be used to group the content items; identify sentiments, activity or trends associated with topics 120; summarize the content items; facilitate the searching of content in the content items; and/or otherwise improve the identification and extraction of important information in the content items by developers and/or designers of online professional network 118.

FIG. 2 shows a topic-mining system (e.g., topic-mining system 102 of FIG. 1) in accordance with the disclosed embodiments. As described above, the topic-mining system may be used to identify topics or themes in a set of content items, such as user comments or feedback associated with use of an online professional network (e.g., online professional network 118 of FIG. 1). As shown in FIG. 2, the topic-mining system includes a tagging apparatus 202 a matching apparatus 204, a cleaning apparatus 206, and an extraction apparatus 208. Each of these components is described in further detail below.

Tagging apparatus 202 may obtain a set of content items from content repository 134 and generate a set of POS tags (e.g., POS tag 1 222, POS tag m 224) for lexical items (e.g., lexical item 1 218, lexical item m 220) in each content item (e.g., article, post, comment, response, complaint, discussion, sentence, document, etc.). For example, tagging apparatus 202 may use NLP techniques such as the Viterbi technique, the Brill tagger, a constraint grammar, and/or the Baum-Welch technique to convert the sentence “I went to Washington park yesterday” into a POS sequence of “I/PRP went/VBD to/TO Washington/NNP park/NN yesterday/NN./.”

Next, matching apparatus 204 may match the POS tags and/or sequences to one or more POS tagging patterns 210 to obtain a set of candidate topics (e.g., candidate topic 1 212, candidate topic n 214) for the content items. In one or more embodiments, POS tagging patterns 210 include a recursive noun phrase, which is represented by the following regular expression: ([a-z]+(JJ)) *([a-z]+NN[P|S|PS]*)+. The noun phrase may be preceded by zero or more other noun phrases and/or modifiers. As a result, a phrase of “secondary account” with a POS sequence of “secondary/JJ account/NN” may be matched to the regular expression for the recursive noun phrase to obtain a candidate topic of “account.”

POS tagging patterns 210 may also include a noun phrase followed by a verb phrase, which is represented by the following regular expression: ([a-z]+(JJ))*([a-z]+NN[P|S|PS]*)+([a-z]+VB[D|G|N|P|Z])+. In the POS tagging pattern containing a noun phrase followed by a verb phrase, an entity (e.g., noun phrase) may be associated with an action (e.g., verb phrase). For example, the POS tagging pattern of a noun phrase followed by a verb phrase may match text such as “application crashed,” “account closed,” or “payment transaction failed,” with POS sequences of “application/NN crashed/VBD,” “account/NN closed/VBD,” and “payment/JJ transaction/NN failed/VBD,” respectively.

POS tagging patterns 210 may further include a verb phrase followed by a noun phrase, which is represented by the following regular expression: ([a-z]+VB[D|G|N|P|Z]*)+[([a-z]+(JJ))*|([a-z]+(PRP[$]))*|([a-z]+(DT))*|([a-z]+(CD)*([a-z]+(TO))*]*([a-z]+NN[P|S|PS]*)+. The verb phrase may be separated from the noun phrase by modifiers such as pronouns or adjectives. For example, a verb phrase followed by a noun phrase may be matched to text such as “merge my accounts” or “merge other accounts,” with POS sequences of “merge/VBP my/PRP$ accounts/NN” and “merge/VBP other/JJ accounts/NN,” respectively, to obtain a candidate topic of “merge accounts.”

After the candidate topics are generated by matching apparatus 204, cleaning apparatus 206 may clean the candidate topics to generate a smaller set of cleaned candidate topics (e.g., cleaned candidate topic 1 226, cleaned candidate topic x 228). To clean the candidate topics, cleaning apparatus 206 may performing stemming of the candidate topics. For example, stemming of inflected words in the candidate topics may transform three candidate topics of “view profile,” “view profiles,” and “viewed profile” into the same cleaned candidate topic of “view profile.” During stemming-related merging of candidate topics, words that appear most frequently among the inflected words (e.g., “view” and “profile”) may be selected for inclusion in the final cleaned candidate topic (e.g., “view profile”).

Cleaning of the candidate topics may also include removing stop words from the candidate topics. For example, common stop words such as articles, prepositions, pronouns, conjunctions, particles, and/or other function words may be removed from the candidate topics. As a result, candidate topics of “close the account” and “closed his account” may be processed into the same cleaned candidate topic of “close account.”

To further facilitate cleaning of the candidate topics, domain-specific stop words that do not add value to the candidate topics may also be removed. For example, domain-specific stop words associated with use of an online professional network may include words or phrases such as “additional information,” “first time,” “contact us,” “please contact,” “further information,” “original message,” “get message,” “please fix,” “same problem,” “someone,” “something,” “received email,” “version,” “website,” “other sites,” “clicking the link,” “.com,” and “user agreement.”

Cleaning apparatus 206 may further clean the candidate topics by merging synonyms and/or semantically related lexical items in the set of candidate topics. For example, cleaning apparatus 206 may use a domain-specific synonym dictionary to match synonyms such as “email address” and “email account” and merge the synonyms into a common topic. Cleaning apparatus 206 may similarly use a lexical database to relate and/or merge semantically related words such as “link,” “connection,” “association,” “partnership,” and “relationship.”

Finally, extraction apparatus 208 may use a filter 216 to extract a set of topics (e.g., topic 1 230, topic y 232) from the cleaned candidate topics. For example, extraction apparatus 208 may use metrics such as term frequency (TF), document frequency (DF), and/or term frequency-inverse document frequency (tf-idf) to filter the cleaned candidate topics so that a pre-specified number of cleaned candidate topics with the best metrics and/or with metrics above or below a pre-specified threshold are included in the topics.

By using NLP techniques and POS tagging patterns 210 to generate and merge candidate topics for content items, the system of FIG. 2 may mitigate the generation of overlapping topics associated with metric-based topic mining. At the same time, the efficient execution of tagging apparatus 202, matching apparatus 204, cleaning apparatus 206, and extraction apparatus 208 may allow the system to scale to data set of different sizes and/or domains.

In turn, topics generated by the system may facilitate understanding and use of information in the content items without requiring manual review of the content items. For example, the content items may be grouped by topic, and key words or phrases from content items in each group may be extracted and included in a content summary for the corresponding topic. Searching of the content items by topic may also be enabled, and activity, sentiments, and/or trends associated with each topic may be tracked.

Those skilled in the art will appreciate that the system of FIG. 2 may be implemented in a variety of ways. First, tagging apparatus 202, matching apparatus 204, cleaning apparatus 206, extraction apparatus 208, and content repository 134 may be provided by a single physical machine, multiple computer systems, one or more virtual machines, a grid, one or more databases, one or more filesystems, and/or a cloud computing system. Tagging apparatus 202, matching apparatus 204, cleaning apparatus 206, and extraction apparatus 208 may additionally be implemented together and/or separately by one or more hardware and/or software components and/or layers.

Second, a number of NLP techniques and/or POS tagging patterns (e.g., POS tagging patterns 210) may be used to identify topics in content items from content repository 134. For example, POS tags for content items may be generated using a number of NLP techniques, such as the Viterbi technique, the Brill tagger, a constraint grammar, and/or the Baum-Welch technique. Furthermore, different POS tagging patterns may be used to extract candidate topics from POS sequences associated with different domains.

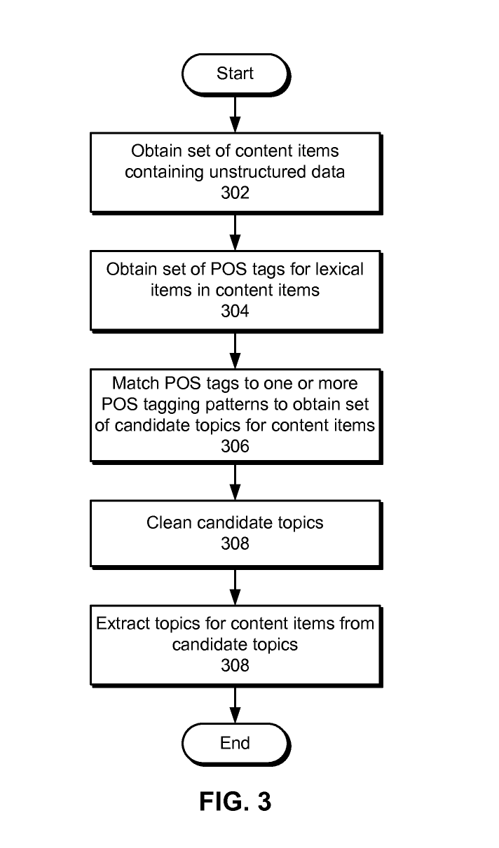

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of content items containing unstructured data is obtained (operation 302). The content items may include customer surveys, complaints, reviews, group discussions, and/or social media content. For example, the content items may contain feedback and/or user comments related to use of an online professional network. Alternatively, the content items may contain unstructured data related to other domains.

Next, a set of POS tags is obtained for lexical items in the content items (operation 304). For example, the content items may be analyzed using NLP techniques to identify POS tags for lexical items (e.g., words, parts of words, phrases, etc.) in each content item. The POS tags may be added to the lexical items to generate POS sequences for the content items.

The POS tags are then matched to one or more POS tagging patterns to obtain a set of candidate topics for the content items (operation 306). The POS tagging patterns may include a recursive noun phrase, a noun phrase followed by a verb phrase, and/or a verb phrase followed by a noun phrase. The candidate topics are also cleaned (operation 308) to reduce overlap and/or unnecessary words or phrases in the candidate topics. For example, the set of candidate topics may be cleaned by performing stemming of the set of candidate topics, removing stop words from the set of candidate topics, merging synonyms in the set of candidate topics, and/or merging semantically related lexical items in the set of candidate topics.

Finally, topics for the content items are extracted from the candidate topics (operation 308). To extract the topics from the candidate topics, the candidate topics may be filtered by a metric associated with the candidate topics, such as TF, DF, and/or tf-idf.

The topics may then be used to provide information regarding the themes and/or trends associated with the content items. For example, account-related user complaints with an online professional network may include topics such as “primary account,” “merge accounts,” “close account,” “duplicate accounts,” and “secondary account.” Advertising-related user complaints with the online professional network may include topics such as “linkedin ads,” “credit card,” “business account,” “ad campaign,” “linkedin company page,” “linkedin advertising,” “sponsored updates,” and “advertising campaign.” Profile-related user complaints with the online professional network may include topics such as “remove connection,” “address book,” “import contacts,” “sent invitations,” and “pending invitations.” The topics may be used to classify and/or group the user complaints for further processing by customer service representatives, identify sentiments associated with the topics, facilitate searching of the user complaints, and/or generate summaries of content associated with the topics.

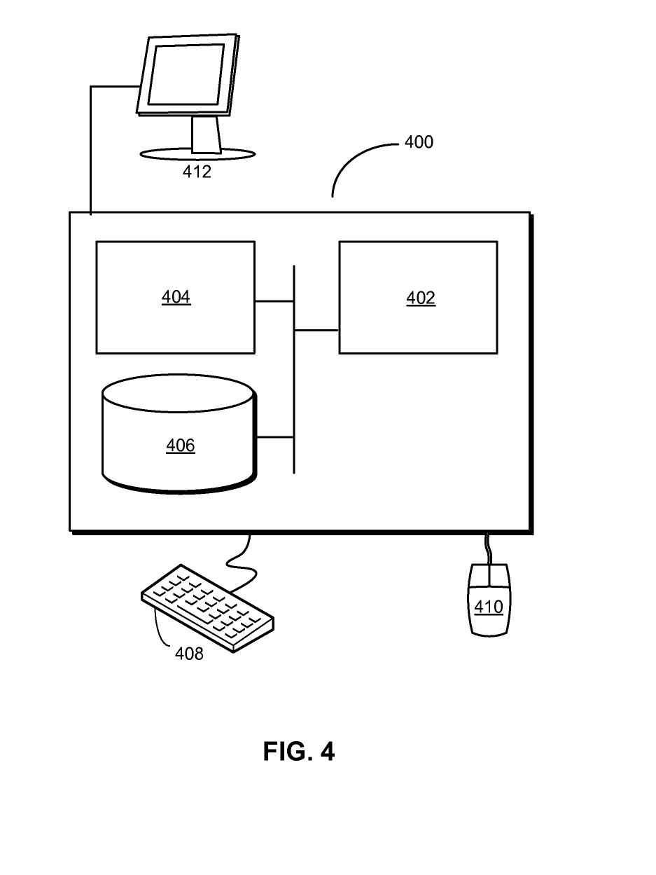

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include a tagging apparatus that obtains a set of content items comprising unstructured data and a set of part-of-speech (POS) tags for lexical items in the set of content items. The system may also include a matching apparatus that matches the POS tags to one or more POS tagging patterns to obtain a set of candidate topics for the set of content items, as well as a cleaning apparatus that cleans the set of candidate topics prior to extracting the set of topics from the candidate topics. Finally, the system may include an extraction apparatus that extracts a set of topics for the set of content items from the set of candidate topics.

In addition, one or more components of computer system 400 may be remotely located and connected to the other components over a network. Portions of the present embodiments (e.g., tagging apparatus, matching apparatus, cleaning apparatus, extraction apparatus, etc.) may also be located on different nodes of a distributed system that implements the embodiments. For example, the present embodiments may be implemented using a cloud computing system that generates topics for content items obtained from a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for processing data, comprising:
obtaining a set of content items comprising unstructured data;
obtaining a set of part-of-speech (POS) tags for lexical items in the set of content items; and
using a computer to:
match the POS tags to one or more POS tagging patterns to obtain a set of candidate topics for the set of content items; and
extract a set of topics for the set of content items from the set of candidate topics.

2. The computer-implemented method of claim 1, further comprising:
cleaning the set of candidate topics prior to extracting the set of topics from the candidate topics.

3. The computer-implemented method of claim 2, wherein cleaning the set of candidate topics comprises at least one of:
performing stemming of the set of candidate topics;
removing stop words from the set of candidate topics;
merging synonyms in the set of candidate topics; and
merging semantically related lexical items in the set of candidate topics.

4. The computer-implemented method of claim 3, wherein the stop words and the synonyms are associated with use of an online professional network.

5. The computer-implemented method of claim 1, wherein the one or more POS tagging patterns comprise:
a recursive noun phrase;
a noun phrase followed by a verb phrase; and
the verb phrase followed by the noun phrase.

6. The computer-implemented method of claim 1, wherein extracting the set of topics from the set of candidate topics comprises:
filtering the candidate topics by a metric associated with the candidate topics.

7. The computer-implemented method of claim 6, wherein the metric is at least one of:
a term frequency;
a document frequency; and
an inverse document frequency.

8. The computer-implemented method of claim 1, wherein the set of content items comprises at least one of:
a customer survey;
a complaint;
a review;
a group discussion; and
social media content.

9. A system for processing data, comprising:
a tagging apparatus configured to:
obtain a set of content items comprising unstructured data; and
obtain a set of part-of-speech (POS) tags for lexical items in the set of content items;
a matching apparatus configured to match the POS tags to one or more POS tagging patterns to obtain a set of candidate topics for the set of content items; and
an extraction apparatus configured to extract a set of topics for the set of content items from the set of candidate topics.

10. The system of claim 9, further comprising:
a cleaning apparatus configured to clean the set of candidate topics prior to extracting the set of topics from the candidate topics.

11. The system of claim 10, wherein cleaning the set of candidate topics comprises at least one of:
performing stemming of the set of candidate topics;
removing stop words from the set of candidate topics;
merging synonyms in the set of candidate topics; and
merging semantically related lexical items in the set of candidate topics.

12. The system of claim 9, wherein the one or more POS tagging patterns comprise:
a recursive noun phrase;
a noun phrase followed by a verb phrase; and
the verb phrase followed by the noun phrase.

13. The system of claim 9, wherein extracting the set of topics from the set of candidate topics comprises:
filtering the candidate topics by a metric associated with the candidate topics.

14. The system of claim 9, wherein the set of content items comprises at least one of:
a customer survey;
a complaint;
a review;
a group discussion; and
social media content.

15. An apparatus, comprising:
one or more processors; and
memory storing instructions that, when executed by the one or more processors, cause the apparatus to:
obtain a set of content items comprising unstructured data;
obtain a set of part-of-speech (POS) tags for lexical items in the set of content items;
match the POS tags to one or more POS tagging patterns to obtain a set of candidate topics for the set of content items; and
extract a set of topics for the set of content items from the set of candidate topics.

16. The apparatus of claim 15, wherein the instructions further cause the apparatus to:
clean the set of candidate topics prior to extracting the set of topics from the candidate topics.

17. The apparatus of claim 16, wherein cleaning the set of candidate topics comprises at least one of:
performing stemming of the set of candidate topics;
removing stop words from the set of candidate topics;
merging synonyms in the set of candidate topics; and
merging semantically related lexical items in the set of candidate topics.

18. The apparatus of claim 15, wherein the one or more POS tagging patterns comprise:
a recursive noun phrase;
a noun phrase followed by a verb phrase; and
the verb phrase followed by the noun phrase.

19. The apparatus of claim 15, wherein extracting the set of topics from the set of candidate topics comprises:
filtering the candidate topics by a metric associated with the candidate topics.

20. The apparatus of claim 15, wherein the set of content items comprises at least one of:
a customer survey;
a complaint;
a review;
a group discussion; and
social media content.
